(19) United States
(12) Patent Application Publication
(10) Pub. No.: US 2020/0280698 A1
(43) Pub. Date: Sep. 3, 2020

(54) IMAGE TRANSMISSION METHOD AND APPARATUS FOR UNMANNED AERIAL VEHICLE

(71) Applicant: SZ DJI TECHNOLOGY CO., LTD., Shenzhen (CN)

(72) Inventors: Huaiyu LIU, Shenzhen (CN); Yifan WU, Shenzhen (CN)

(21) Appl. No.: 16/731,665

(22) Filed: Dec. 31, 2019

Related U.S. Application Data
(63) Continuation of application No. PCT/CN2017/111930, filed on Nov. 20, 2017.

(51) Int. Cl. H04N 7/18; H04N 5/067; H04N 5/232; B64C 39/02

(52) U.S. Cl. CPC H04N 7/181; H04N 5/0675; B64C 2201/127; B64C 39/024; H04N 5/23229

(57) ABSTRACT

An image transmission method includes obtaining multi-channel images shot by a plurality of shooting devices of an unmanned aerial vehicle (UAV) having different shooting directions, and broadcasting the multi-channel images obtained in real time to a plurality of ground-end devices synchronously.

### CROSS-REFERENCE TO RELATED APPLICATION

This application is a continuation of International Application No. PCT/CN2017/111930, filed on Nov. 20, 2017, the entire content of which is incorporated herein by reference.

### TECHNICAL FIELD

The present disclosure relates to the technical field of data transmission for unmanned aerial vehicles (UAVs) and, more particularly, to an image transmission method and apparatus for unmanned aerial vehicle (UAV).

### BACKGROUND

Currently, unmanned aerial vehicle (UAV) systems generally only support point-to-point transmission for transmitting single-channel images. Even if a UAV carries a plurality of shooting devices (e.g., cameras, image sensors, or the like), due to the limitations of a performance of the UAV and a wireless transmission bandwidth, the UAV only transmits the single-channel images to a ground-end device. It is impossible for a UAV user to observe omnidirectional images viewed from multiple perspectives at the same time. It is difficult to obtain global scene information, such that optimal judgments cannot be determined during a control operation, and a better panoramic experience cannot be obtained. In addition, in the situation of flying out of sight or performing an immersive first-view flight, the single-channel image transmission is accompanied by certain safety risks. The role and upgrade experience of UAVs in industrial applications, aerial photography, entertainment, and other application scenarios are affected.

### SUMMARY

In accordance with the disclosure, there is provided an image transmission method including obtaining multi-channel images shot by a plurality of shooting devices of an unmanned aerial vehicle (UAV) having different shooting directions, and broadcasting the multi-channel images obtained in real time to a plurality of ground-end devices synchronously.

### BRIEF DESCRIPTION OF THE DRAWINGS

In order to provide a clearer illustration of technical solutions of disclosed embodiments, the drawings used in the description of the disclosed embodiments are briefly described below. It will be appreciated that the disclosed drawings are merely examples. Other drawings can be conceived by those having ordinary skills in the art on the basis of the disclosed drawings without inventive efforts.

FIG. 1 is a schematic flow chart of an image transmission method for an unmanned aerial vehicle (UAV) implemented in the UAV consistent with embodiments of the disclosure.

FIG. 2 is a schematic flow chart of another image transmission method for a UAV implemented in a ground-end device consistent with embodiments of the disclosure.

FIG. 3 is a schematic structural diagram of an image transmission apparatus for a UAV consistent with embodiments of the disclosure.

FIG. 4 is a schematic structural diagram of another image transmission apparatus for a UAV consistent with embodiments of the disclosure.

FIG. 5 is a schematic structural diagram of another image transmission apparatus for a UAV consistent with embodiments of the disclosure.

### DETAILED DESCRIPTION OF THE EMBODIMENTS

In order to provide a clearer illustration of technical solutions of disclosed embodiments, example embodiments will be described with reference to the accompanying drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

Hereinafter, an image transmission method and apparatus for an unmanned aerial vehicle (UAV) consistent with the present disclosure will be described in detail below with reference to the drawings. Unless conflicted, the features of the following embodiments and implementations can be combined with each other.

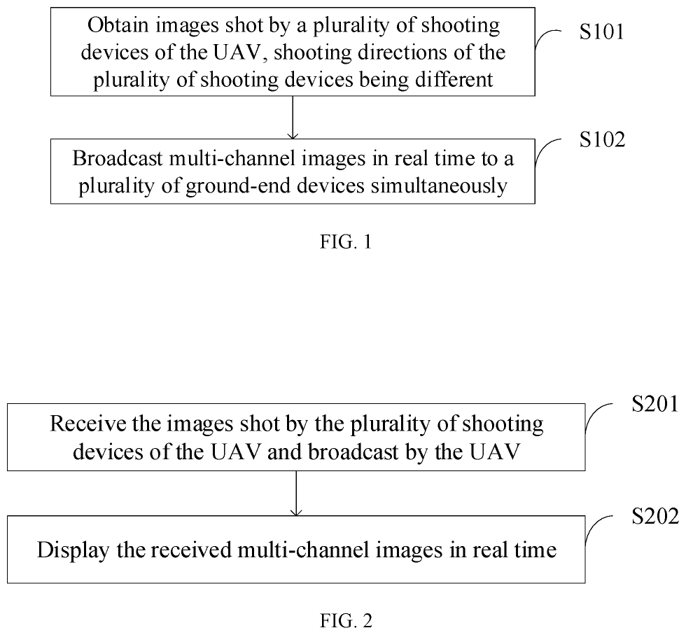

Herein, an image may refer to a still image or a video stream. FIG. 1 is a schematic flow chart of an image transmission method for a UAV consistent with the disclosure. An execution entity of the image transmission method for the UAV can be the UAV itself. As shown in FIG. 1, at S101, images shot by a plurality of shooting devices of the UAV are obtained. Shooting directions of the plurality of shooting devices can be different.

Each shooting device can include a camera, an image sensor, or other types of shooting device. The number of the plurality of shooting devices, installation positions of the plurality of shooting devices of the UAV, and the shooting direction of each shooting device can be selected according to environment information of a location of the UAV required by the user. For example, the UAV can include two shooting devices. One of them can be arranged at a nose of the UAV, and another can be arranged at a tail of the UAV. The shooting device at the nose can be configured to shoot the images from a forward-facing perspective of the UAV, and the shooting device at the tail can be configured to shoot the images from a backward-facing perspective of the UAV, thereby providing the user with omnidirectional information about the location of the UAV.

At S102, multi-channel images obtained in real time are broadcast to a plurality of ground-end devices synchronously. The multi-channel images refer to images shot by the plurality of shooting devices, and each channel of the multi-channel images corresponds to one of the plurality of shooting devices. The UAV can communicate with the plurality of ground-end devices. The UAV and the plurality of ground-end devices can be connected using, for example, at least one of a wired communication or a wireless communication, which can be selected according to needs. In some embodiments, the UAV and the plurality of ground-end devices can be connected using the wireless communication, which does not limit a flying distance of the UAV. The UAV can synchronously broadcast the multi-channel images obtained in real time to the plurality of the ground-end devices using the wireless communication.

In some embodiments, each ground-end device may include at least one of a remote control, a removable device (e.g., a mobile phone, a smart watch, a tablet computer, or the like), or a head-mount display device (e.g., video glasses). The ground-end device is not limited to the devices described above, but can also include other devices that can communicate with the UAV. In some embodiments, the plurality of ground-end devices can be the same type of device or different types of devices.

The multi-channel images refer to the images shot by the plurality of shooting devices of the UAV. The plurality of ground-end devices can include a plurality of default ground-end devices, or can be selected according to a user requirement. For example, the plurality of default ground-end devices can include a mobile device and a head-mount device. The UAV can store a terminal identification of the mobile device and a terminal identification of the head-mount device. After obtaining the images shot by the plurality of shooting devices of the UAV, the UAV can broadcast the multi-channel images obtained in real time to the corresponding mobile device and head-mount device according to the terminal identification of the mobile device and the terminal identification of the head-mount device.

In some embodiments, the method may further include, before implementing the process at S102, receiving terminal information corresponding to the plurality of the ground-end devices inputted by a user. The terminal information can include, for example, the terminal identifications of the plurality of the ground-end devices. The users can send the terminal information to the UAV through any ground-end device, or directly input the terminal information corresponding to the plurality of ground-end devices to the UAV, thereby notifying the UAV about the plurality of ground-end devices waiting for receiving the multi-channel images. As such, the implementation of the method can be flexible. After receiving the terminal information corresponding to the plurality of ground-end devices inputted by the user, the UAV can synchronously broadcast the multi-channel images obtained in real time to the plurality of ground-end devices according to the terminal information corresponding to the plurality of ground-end devices. As such, the user can obtain the environmental information of a current location of the UAV through the plurality of ground-end devices.

Consistent with the disclosure, the images shot by the plurality of shooting devices of the UAV can be transmitted to the plurality of ground-end devices synchronously through broadcast, such that the UAV can support a multi-channel image transmission. The omnidirectional information (e.g., the image information from multiple perspectives) of the location of the UAV can be transmitted to multiple users, and multi-directional obstacle information can be provided, and hence, the users can be guided according to the multi-directional obstacle information during the operation. A flight safety can be improved and the multiple users can be provided with a more realistic panorama experience. In addition, a multiple user operation can be supported, such that the multiple users can work together. The image transmission method can be suitable for application scenarios, such as, flying from a first perspective, security monitoring, fire protection, disaster relief, pipeline inspection, robot events, and the like.

In some embodiments, the UAV can implement the processes at S102 in response to the UAV determining that a condition is satisfied. In some embodiments, the condition can include the UAV receiving a multi-channel image request sent by any ground-end device. Some channels of the multi-channel images can be selectively transmitted according to actual needs of the multiple users. That is, the multi-channel images shot by all of the plurality of shooting devices of the UAV do not need to be transmitted at the same time, thereby saving a channel bandwidth. The multi-channel image request may include the device information of the shooting devices corresponding to the multi-channel images to be requested. The multi-channel images to be requested can be all of the multi-channel images or some of the multi-channel images. Based on the device information of the shooting devices corresponding to the multi-channel images to be requested, the UAV can obtain the images shot by the shooting devices corresponding to the multi-channel images to be requested, and then broadcast the multi-channel images to be requested obtained in real time to the plurality of ground-end devices synchronously. The user may select the images shot by a certain shooting device of the UAV according to the need. For example, the plurality of shooting devices of the UAV may include shooting device 1, shooting device 2, shooting device 3, and shooting device 4. Shooting device 1 can be configured to shoot the images from the forward-facing perspective of the UAV, shooting device 2 can be configured to shoot the images from the backward-facing perspective of the UAV, shooting device 3 can be configured to shoot the images from a left-facing perspective of the UAV, and shooting device 4 can be configured to shoot the image from a right-facing perspective of the UAV. When the user needs to obtain the images from the forward-facing perspective, the left-facing perspective, and the right-facing perspective of the UAV, the device information of shooting device 1, the device information of shooting device 3, and the device information of shooting device 4 can be inputted into any ground-end device. The ground-end device can generate the multi-channel image request based on the device information of shooting device 1, the device information of shooting device 3, and the device information of shooting device 4, and can transmit the device information to the UAV. The UAV can broadcast the images shot by shooting device 1, shooting device 3, and shooting device 4 to the plurality of ground-end devices. The device information can include a device identifier of each shooting device.

In some other embodiments, the condition can include that the UAV obtains the images shot by all of the plurality of the shooting devices of the UAV. After obtaining the images shot by all of the plurality of the shooting devices of the UAV, the UAV can synchronously broadcast the images shot by all of the plurality of the shooting devices to the plurality of the ground-end devices. As such, the information obtained by users can be more comprehensive, thereby better guiding the operations of the UAV, and improving the flight safety of UAV.

In some embodiments, the method can further include, before implementing the process at S102, encoding the multi-channel images obtained in real time. An amount of data broadcast by the UAV can be reduced by removing redundant information in the images from each channel of the multi-channel images. Broadcasting the multi-channel images obtained in real time to the plurality of ground-end devices synchronously at S102 can include synchronously broadcasting the encoded multi-channel images to the plurality of ground-end devices.

In some embodiments, encoding device(s) can be arranged at the UAV. The one or more encoding devices can be connected to the plurality of the shooting devices, such that the images shot by the plurality of shooting devices can be encoded by the encoding device(s). In some embodiments, multiple encoding devices can be provided. In some embodiments, the number of encoding devices can be equal to the number of the plurality of shooting devices, and the plurality of shooting devices can be correspondingly connected to the multiple encoding devices. The UAV encoding the multi-channel images obtained in real-time can include encoding the images shot by each shooting device using the corresponding encoding device. A processing efficiency of image encoding can be improved by using the multiple encoding devices. In some embodiments, the number of the encoding devices can be more than one but smaller than the number of the plurality of shooting devices. For example, some of the encoding devices can each be connected to one of the plurality of shooting devices, and the other encoding devices can each be connected to at least two of the plurality of shooting devices. Further, each of the shooting devices is connected to only one encoding device. As such, the processing speed of image encoding can be enhanced.

In some other embodiments, one encoding device is provided. The plurality of shooting devices can be connected to the same one encoding device. The UAV encoding the multi-channel images obtained in real time can include encoding the multi-channel images using the same encoding device. Encoding the multi-channel images using the single encoding device can reduce a difficulty of simultaneous transmission of the multi-channel images and can also reduce a cost.

The encoding device can include any existing type of encoder. The images can be encoded according to any suitable encoding method. For example, the encoding device(s) encoding the multi-channel images obtained in real-time can include dividing the images in each channel into a plurality of I slices (i.e., intra-frame slices, each image frame containing multiple slices), thereby reducing the amount of image data transmitted by the UAV. The processes at S102 can include synchronously broadcasting the I slices corresponding to the multi-channel images obtained in real time to the plurality of the ground-end devices. After each ground-end device receives the I slices corresponding to the multi-channel images, if the I slices corresponding to any channel are abnormal, the abnormal I slices can be recovered without the need for the UAV to retransmit the corresponding I slices. The I slices abnormity may include a loss of intra-frame information or inter-frame division information of the image. In some embodiments, The UAV can synchronously broadcast the I slices corresponding to the multi-channel images obtained in real time to the plurality of the ground-end devices according to a preset period. The plurality of ground-end devices can periodically recover the images having the abnormal I slices, such that a stability of the image transmission can be strong.

In some embodiments, the encoding device(s) encoding the multi-channel images obtained in real-time can include obtaining I frames of the images in each channel. Therefore, the amount of image data transmitted by the UAV can be reduced, and an integrity of the image displayed by the plurality of ground-end devices cannot be affected. The processes at S102 can include synchronously broadcasting the I frames corresponding to the multi-channel images obtained in real time to the plurality of the ground-end devices. After the plurality of ground-end devices receive the I frames of the images in each channel, image information of images in each channel can be completely displayed.

In some embodiments, the method can further include, after implementing the processes at S102, in response to receiving abnormal image information transmitted by any ground-end device, obtaining the multi-channel images corresponding to the image abnormal information according to the abnormal image information, and then broadcasting the multi-channel images corresponding to the obtained image abnormal information to the plurality of ground-end devices. In response to detecting that the received image in any channel is abnormal, the ground-end device who received the abnormal image can send the abnormal image information to the UAV, thereby requesting the UAV to retransmit the abnormal image. When the ground-end device receives the I-frames of the multi-channel images broadcast by the UAV, an image abnormality can include an I-frame abnormality, for example, a loss of the I-frame, a distortion rate of the I-frame being greater than or equal to a preset distortion rate, and the like. When the ground-end device receives the I slices of the multi-channel images broadcast by the UAV, the image abnormality can include the I slice abnormality, for example, the loss of intra-frame information or inter-frame division information, and the like. The image abnormality information may include device information of the shooting device and a shooting time corresponding to the abnormal image. After receiving the abnormal image information, the UAV can search the corresponding image according to the device information of the shooting device and the shooting time corresponding to the abnormal image and rebroadcast the searched image to the plurality of the ground-end devices.

FIG. 2 is a schematic flow chart of another image transmission method for the UAV consistent with the disclosure. The execution entity of the image transmission method for the UAV can be the plurality of ground-end devices. In some embodiments, each ground-end device may include at least one of a remote control, a removable device (e.g., a mobile phone, a smart watch, a tablet computer, or the like), or a head-mount display device (e.g., a video glasses). The ground-end device is not limited to the devices described above, but can also include other devices that can communicate with the UAV.

As shown in FIG. 2, at S201, the images shot by the plurality of shooting devices of the UAV and broadcast by the UAV are received. Shooting directions of the plurality of shooting devices can be different. In some embodiments, the plurality of ground-end devices and the UAV can be connected using, for example, at least one of a wired communication or a wireless communication, which can be selected according to needs. In some embodiments, the ground-end devices and the UAV can be connected using the wireless communication, which does not limit the flying distance of the UAV. Each ground-end device can receive the images shot by the plurality of shooting devices of the UAV and broadcast by the UAV using the wireless communication.

In some embodiments, the method may further include, before the ground-end device (e.g., one of the plurality of ground-end devices) implementing the processes at S201, transmitting the multi-channel image request to the UAV. Each of the plurality of ground-end devices can receive the images shot by the shooting devices corresponding to the multi-channel images to be requested and broadcast by the UVA in response to the multi-channel image request. Therefore, some of the multi-channel images can be selectively transmitted according to actual needs of the multiple users. That is, the multi-channel images shot by all the shooting devices of the UAV do not need to be transmitted at the same time, thereby saving the channel bandwidth. The multi-channel image request may include device information of the shooting devices corresponding to the multi-channel images to be requested. Based on the device information of the shooting devices corresponding to the multi-channel images to be requested, the UAV can obtain the images shot by the shooting devices corresponding to the multi-channel images to be requested, and then broadcast the multi-channel images to be requested obtained in real time to the plurality of ground-end devices synchronously.

The plurality of ground-end devices can include the plurality of default ground-end devices, or can be selected according to the user requirement. For example, the plurality of default ground-end devices can include a mobile device and a head-mount device. The UAV can store the terminal identification of the mobile device and the terminal identification of the head-mount device. After obtaining the images shot by the plurality of shooting devices of the UAV, the UAV can broadcast the multi-channel images obtained in real time to the corresponding mobile device and head-mount device according to the terminal identification of the mobile device and the terminal identification of the head-mount device.

In some embodiments, the method may further include, before the ground-end device transmits the multi-channel image request to the UAV, receiving a user instruction, analyzing the device information of the shooting devices corresponding to the multi-channel images to be requested from the user instruction, and transmitting the multi-channel image request to the UAV according to the device information of the shooting devices corresponding to the multi-channel images to be requested. In some embodiments, the user may select the images shot by some of the plurality of shooting devices of the UAV, for example, the multi-channel images to be requested, according to the need. For example, the plurality of shooting devices of the UAV may include shooting device 1, shooting device 2, shooting device 3, and shooting device 4. Shooting device 1 can be configured to shoot the images from the forward-facing perspective of the UAV, shooting device 2 can be configured to shoot the images from the backward-facing perspective of the UAV, shooting device 3 can be configured to shoot the images from the left-facing perspective of the UAV, and shooting device 4 can be configured to shoot the image from the right-facing perspective of the UAV. When the user needs to obtain the images from the forward-facing perspective, left-facing perspective, and right-facing perspective of the UAV, the device information of shooting device 1, the device information of shooting device 3, and the device information of shooting device 4 can be inputted into any ground-end device. The ground-end device can generate the multi-channel image request based on the device information of shooting device 1, the device information of shooting device 3, and the device information of shooting device 4, and can transmit the device information to the UAV. The UAV can broadcast the images shot by shooting device 1, shooting device 3, and shooting device 4 to the plurality of ground-end devices. That is, the multi-channel images to be requested are the images shot by shooting device 1, shooting device 3, and shooting device 4 to the plurality of ground-end devices. The device information can include the device identifier of the shooting device.

In some embodiments, each ground-end device receiving the user instruction may include the following processes. The ground-end device or an application (APP) installed on the ground-end device can display a list of device information corresponding to each shooting device on the current UAV. The user can select the plurality of shooting devices listed in a column as the shooting devices corresponding to the multi-channel images to be requested. After the shooting devices corresponding to the multi-channel images to be requested are selected, a multi-channel image request confirmation button on the ground-end device or the APP installed on the ground-end device can be pressed. The ground-end device can transmit the multi-channel image request carrying the device information of the shooting devices corresponding to the multi-channel images to be requested inputted by the user to the UAV, thereby obtaining the images shot by the shooting devices required by the user.

In some embodiments, a device information input box is provided on the ground-end device or the APP installed on the ground-end device, and the user can input the device information of the shooting devices corresponding to the multi-channel images to be requested into the device information input box. After the device information is inputted, the multi-channel image request confirmation button on the ground-end device or the APP installed on the ground-end device can be pressed. The ground-end device can transmit the multi-channel image request carrying the device information of the shooting devices corresponding to the multi-channel images to be requested inputted by the user to the UAV, thereby obtaining the images of the shooting device required by the user.

At S202, the received multi-channel images are displayed in real time. Each ground-end device can include a display, and the received multi-channel images can be displayed in real time through the display to support the multi-channel image transmission of the device. The omnidirectional information (e.g., the image information from multiple perspectives) of the location of the UAV can be transmitted to the multiple users, and multi-directional obstacle information can be provided, and hence, the users can be guided according to the multi-directional obstacle information during the operation. The flight safety can be improved and the multiple users can be provided with the more realistic panorama experience. In addition, the multiple user's operation can be supported, such that the multiple users can work together. The image transmission method can be suitable for application scenarios, such as, flying from a first perspective, security monitoring, fire protection, disaster relief, pipeline inspection, robot events, and the like. The display can include any existing type of display.

In some embodiments, the method can further include when the received multi-channel images are encoded multi-channel images, decoding the encoded multi-channel images to recover the image information. Each ground-end device can display the decoded multi-channel images in real time. For example, the ground-end device may include a decoding device, and the encoded multi-channel images can be decoded by the decoding device. The decoding device can include any existing type of decoder.

In some embodiments, the method can further include, after the ground-end device decoding the encoded multi-channel images, when the encoded multi-channel images include the plurality of I slices, if the I slices in any channel are abnormal, recovering the abnormal I slices. After the ground-end device receives the I slices corresponding to the multi-channel images, if the I slices in any channel are abnormal, the abnormal I slices can be recovered and processed, and the UAV does not required to retransmit the images having the abnormal I slices. The I slices abnormity may include the loss of intra-frame division information or inter-frame division information of the image. In some embodiments, The UAV can synchronously broadcast the I slices corresponding to the multi-channel images obtained in real time to the plurality of the ground-end devices according to the preset period. The plurality of ground-end devices can periodically recover the images having the abnormal I slices, such that the stability of the image transmission can be strong. When the ground-end device detects the received I slices in any channel are abnormal, the abnormal image information can be sent to the UAV, such that the UAV can rebroadcast the image corresponding to the abnormal image information and the ground-end device can obtain the corresponding image again. The image abnormality information may include the device information of the shooting device and the shooting time corresponding to the abnormal image. After receiving the abnormal image information, the UAV can search the I slices of the corresponding image and rebroadcast the searched image to the plurality of the ground-end devices.

In some embodiments, the method can further include, after decoding the encoded multi-channel images, when the encoded multi-channel images include the I-frames of the corresponding images, if the received I-frames in any channel are determined to be abnormal, transmitting the abnormal image information to the UAV, such that the UAV can rebroadcast the I-frames corresponding to the abnormal image information and the ground-end device can obtain the corresponding image again. The I-frame abnormality can include, for example, the loss of the I-frame, the distortion rate of the I-frame being greater than or equal to the preset distortion rate, and the like. The image abnormality information may include the device information of the shooting device and the shooting time corresponding to the abnormal image. After receiving the abnormal image information, the UAV can search the corresponding image according to the device information of the shooting device and the shooting time corresponding to the abnormal image and rebroadcast the searched image to the plurality of the ground-end devices.

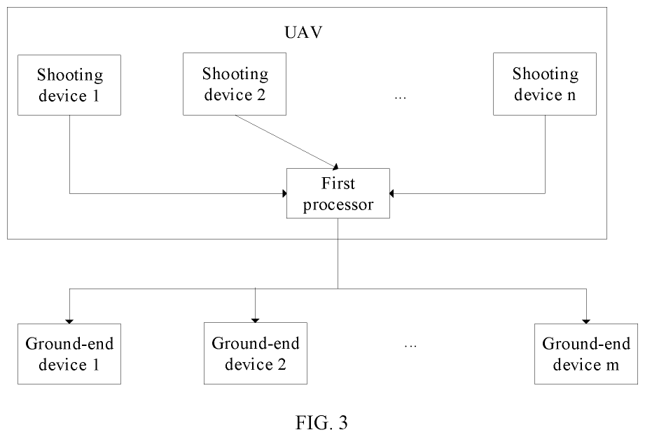

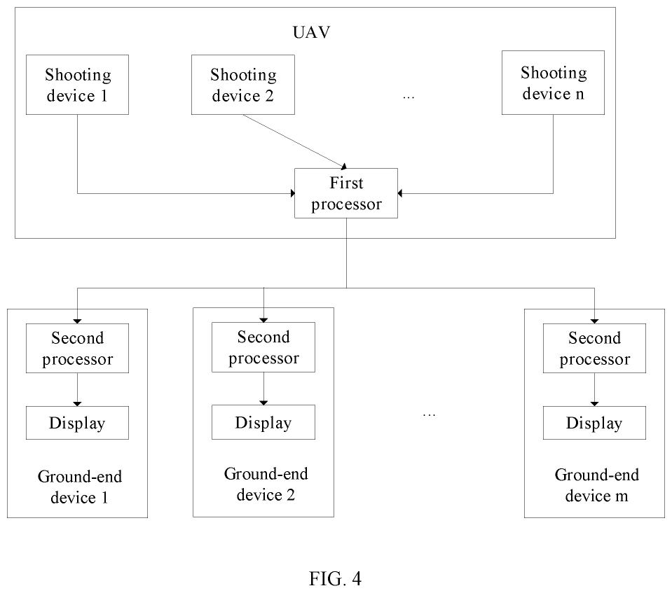

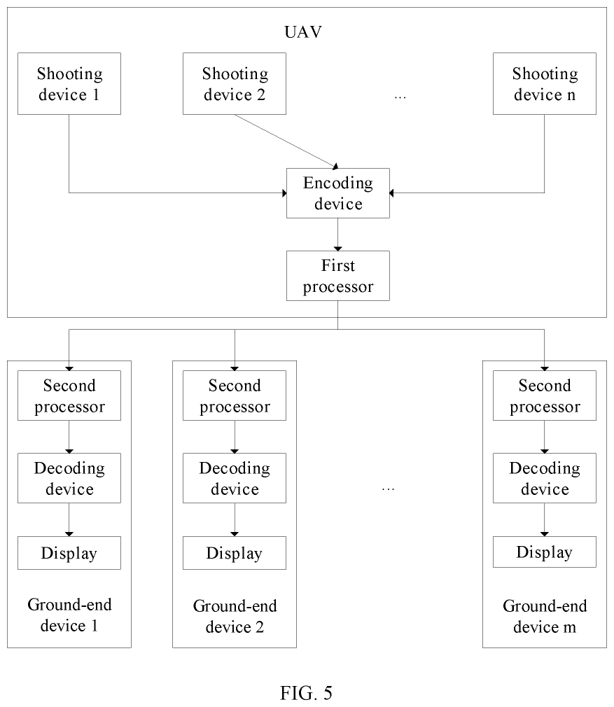

FIG. 3 is a schematic structural diagram of an example image transmission apparatus for a UAV consistent with the disclosure. FIG. 4 is a schematic structural diagram of another example image transmission apparatus for the UAV consistent with the disclosure. FIG. 5 is a schematic structural diagram of another example image transmission apparatus for the UAV consistent with the disclosure. The image transmission apparatuses arranged at the UAV will be described in detail herein. As shown in FIGS. 3 to 5, the image transmission apparatus arranged at the UAV is configured to cooperate with the plurality of ground-end devices (e.g., ground-end device 1, ground-end device 2, . . . , ground-end device m, where m is a positive integer), such that the images shot by the plurality of shooting devices of the UAV can be transmitted to the plurality of ground-end devices. In some embodiments, each ground-end device may include at least one of a remote control, a removable device (e.g., a mobile phone, a smart watch, a tablet computer, or the like), or a head-mount display device (e.g., a video glasses). The ground-end device is not limited to the devices described above, but can also include other devices that can communicate with the UAV.

The image transmission apparatus of the UAV includes a first processor and the plurality of shooting devices (which may include shooting device 1, shooting device 2, . . . , shooting device n, where n is a positive integer). The first processor can be communicatively connected to the plurality of the ground-end devices. The first processor and the plurality of ground-end devices can be connected using, for example, at least one of a wired communication or a wireless communication, which can be selected according to needs. In some embodiments, the first processor and a second processor of each ground-end device can be connected using the wireless communication, which does not limit the flying distance of the UAV. The first processor can synchronously broadcast the multi-channel images obtained in real time to the second processors of the plurality of the ground-end devices using the wireless communication. In some embodiments, the wireless communication connections between the first processor and the second processors can be achieved by using a high-bandwidth, low-latency wireless transmission device, as such a simultaneous transmission of multiple video streams (having a resolution of, for example, 2160×1440, 1920×1080, or the like) can be supported.

Each shooting device can be communicatively connected to the first processor, and each shooting device can send the shot image to the first processor. Shooting directions of the plurality of shooting devices can be different. Each shooting device can include a camera, an image sensor, or other types of shooting device. The number of the plurality of shooting devices, the installation positions of the plurality of shooting devices of the UAV, and the shooting direction of each shooting device can be selected according to the environment information of the location of the UAV required by the user. For example, the UAV can include two shooting devices. One of them can be arranged at the nose of the UAV, and another can be arranged at the tail of the UAV. The shooting device at the nose can be configured to shoot the images from the forward-facing perspective of the UAV, and the shooting device at the tail can be configured to shoot the images from the backward-facing perspective of the UAV, thereby providing the user with omnidirectional information about the location of the UAV.

In some embodiments, the image transmission apparatus can include one or more first processors operating individually or collectively. The first processor may be configured to obtain images shot by the plurality of shooting devices of the UAV, and broadcast the multi-channel images obtained in real time to the plurality of the ground-end devices synchronously. The first processor may include a flight controller of the UAV, or another controller arranged at the UAV.

Consistent with the disclosure, the images shot by the plurality of shooting devices of the UAV can be transmitted to the plurality of ground-end devices synchronously through broadcast, such that the UAV can support the multi-channel image transmission. The omnidirectional information (e.g., the image information from multiple perspectives) of the location of the UAV can be transmitted to the multiple users, and the multi-directional obstacle information can be provided, and hence, the users can be guided according to the multi-directional obstacle information during the operation. The flight safety can be improved and the multiple users can be provided with the more realistic panorama experience. In addition, the multiple user's operation can be supported, such that the multiple users can work together. The image transmission apparatus can be suitable for application scenarios, such as, flying from a first perspective, security monitoring, fire protection, disaster relief, pipeline inspection, robot events, and the like.

In some embodiments, the first processor can be further configured to, before broadcasting the multi-channel images obtained in real time to the plurality of ground-end devices synchronously, receive the terminal information corresponding to the plurality of the ground-end devices inputted by the user. According to the terminal information corresponding to the plurality of ground-end devices, the multi-channel images obtained in real time can be broadcast synchronously to the plurality of ground-end devices, such that the users can obtain the environmental information of the current location of the UAV through the plurality of ground-end devices. The users can send the terminal information to the first processor through any ground-end device, or directly input the terminal information corresponding to the plurality of ground-end devices to the first processor, thereby notifying the processor about the plurality of ground-end devices waiting for receiving the multi-channel images. As such, the operation of the image transmission apparatus can be flexible.

In some embodiments, the first processor can be further configured to broadcast the multi-channel images obtained in real time to the plurality of ground-end devices synchronously, after the first processor determines that the condition is satisfied. In some embodiments, the condition can include the first processor receiving the multi-channel image request sent by any ground-end device. Some channels of the multi-channel images can be selectively transmitted according to the actual needs of the multiple users. That is, the multi-channel images shot by all of the plurality of shooting devices of the UAV do not need to be transmitted at the same time, thereby saving the channel bandwidth. The multi-channel image request may include the device information of the shooting devices corresponding to the multi-channel images to be requested. Based on the device information of the shooting devices corresponding to the multi-channel images to be requested, the first processor can obtain the images shot by the shooting devices corresponding to the multi-channel images to be requested, and then, broadcast the multi-channel images to be requested obtained in real time to the plurality of ground-end devices synchronously. The user may select the images shot by a certain shooting device of the UAV according to the need. For example, the plurality of shooting devices of the UAV may include shooting device 1, shooting device 2, shooting device 3, and shooting device 4. Shooting device 1 can be configured to shoot the images from the forward-facing perspective of the UAV, shooting device 2 can be configured to shoot the images from the backward-facing perspective of the UAV, shooting device 3 can be configured to shoot the images from the left-facing perspective of the UAV, and shooting device 4 can be configured to shoot the image from the right-facing perspective of the UAV. When the user needs to obtain the images from the forward-facing perspective, the left-facing perspective, and the right-facing perspective of the UAV, the device information of shooting device 1, the device information of shooting device 3, and the device information of shooting device 4 can be inputted into any ground-end device. The ground-end device can generate the multi-channel image request based on the device information of shooting device 1, the device information of shooting device 3, and the device information of shooting device 4, and can transmit the device information to the first processor. The first processor can broadcast the images shot by shooting device 1, shooting device 3, and shooting device 4 to the plurality of ground-end devices. The device information can include the device identifier of each shooting device.

In some other embodiments, the condition can include that the first processor obtains the images shot by all of the plurality of the shooting devices of the UAV. After obtaining the images shot by all of the plurality of the shooting devices of the UAV, the first processor can synchronously broadcast the images shot by all of the plurality of the shooting devices to the plurality of the ground-end devices. As such, the information obtained by users can be more comprehensive, thereby better guiding the operations of the UAV, and improving the flight safety of UAV.

In some embodiments, the image transmission apparatus for the UAV may further include the encoding device(s). The encoding device(s) can be communicatively connected to the first processor and the plurality of the shooting devices. The plurality of the shooting devices can transmit the shot images to the encoding device(s), the encoding device(s) can encode the multi-channel images obtained in real time, and the first processor can synchronously broadcast the encoded multi-channel images to the plurality of the ground-end devices. The redundant information in the images from each channel of the multi-channel images can be removed by the encoding device(s), such that the amount of data broadcast by the first processor can be reduced.

One or more encoding devices can be provided. In some embodiments, multiple encoding devices can be provided to cooperate with the plurality of the shooting devices. Each encoding device can be communicatively connected to the first processor. Each encoding device can encode the images shot by the corresponding shooting device, and can send the obtained encoded images to the first processor. The first processor can broadcast the encoded multi-channel images to the plurality of ground-end devices synchronously, such that the processing efficiency of image encoding can be improved by using the multiple channel encoding device. In some embodiments, the number of the encoding devices can be equal to the number of the plurality of shooting devices, and the plurality of shooting devices can be correspondingly connected to the multiple encoding devices. In some other embodiments, the number of the encoding devices can be more than one but smaller than the number of the plurality of shooting devices. For example, some of the encoding devices can each be connected to one of the plurality of shooting devices, and the other encoding devices can each be connected to at least two of the plurality of shooting devices. Further, each of the shooting devices is connected to only one encoding device. As such, the processing speed of image encoding can be enhanced.

In some embodiments, only one encoding device is provided, which is communicatively connected to the plurality of shooting devices. The single encoding device can synchronously encode the images shot by the plurality of shooting devices, and the first processor can broadcast the encoded multi-channel images to the plurality of ground-end devices synchronously. Encoding the multi-channel images using the single encoding device can reduce the difficulty of simultaneous transmission of the multi-channel images and can also reduce the cost.

The encoding device can include any existing type of encoder. The images can be encoded according to any suitable encoding method. In some embodiments, the encoding device(s) encoding the multi-channel images obtained in real-time can include the following processes. The encoding device(s) can divide the images in each channel into the plurality of I slices (i.e., intra-frame slices, each image frame containing multiple slices). The first processor can synchronously broadcast the I slices corresponding to the multi-channel images obtained in real time to the plurality of ground-side devices, thereby reducing the amount of image data transmitted by the UAV. After each ground-end device receives the I slices corresponding to the multi-channel images, if the I slices corresponding to any channel are abnormal, the abnormal I slices can be recovered without the need for the UAV to retransmit the corresponding I slices. The I slices abnormity may include the loss of intra-frame division information or inter-frame division information of the image. In some embodiments, The first processor can synchronously broadcast the I slices corresponding to the multi-channel images obtained in real time to the plurality of the ground-end devices according to the preset period. The plurality of ground-end devices can periodically recover the images having the abnormal I slices, such that the stability of the image transmission can be strong.

In some embodiments, the encoding device(s) encoding the multi-channel images obtained in real-time can include the following processes. The encoding device(s) can obtain the I frames of the images in each channel. The first processor can synchronously broadcast the I frames corresponding to multi-channel images obtained in real time to the plurality of the ground-end devices, such that the amount of image data transmitted by the UAV can be reduced, and the integrity of the image displayed by the plurality of ground-end devices cannot be affected. After the plurality of ground-end devices receive the I frames of the images in each channel, the image information of images in each channel can be completely displayed.

In some other embodiments, there is no need to include separate encoding device(s), and the functions of the encoding device(s) can be performed by the first processor.

In some embodiments, after the first processor synchronously broadcasts the encoded multi-channel images to the plurality of ground-end devices, in response to receiving the abnormal image information transmitted by any ground-end device, the first processor can be configured to obtain the multi-channel images corresponding to the image abnormal information according to the abnormal image information, and broadcast the multi-channel images corresponding to the obtained image abnormal information to the plurality of ground-end devices. In response to detecting that the received image in any channel is abnormal, the ground-end device who received the abnormal image can send the abnormal image information to the first processor, thereby requesting the first processor to retransmit the abnormal image. When the plurality of ground-end devices receive the I-frames of the multi-channel images broadcast by the first processor, the image abnormality can include the I-frame abnormality, for example, the loss of the I-frame, the distortion rate of the I-frame being greater than or equal to the preset distortion rate, and the like. When the plurality of ground-end devices receive the I slices of the multi-channel images broadcast by the first processor, the image abnormality can include the I slice abnormality, for example, the loss of intra-frame division information or inter-frame division information, and the like. The image abnormality information may include the device information of the shooting device and the shooting time corresponding to the abnormal image. After receiving the abnormal image information, the first processor can search the corresponding image according to the device information of the shooting device and the shooting time corresponding to the abnormal image and rebroadcast the searched image to the plurality of the ground-end devices.

The image transmission apparatuses arranged at the plurality of ground-end devices will be described in detail herein. As shown in FIGS. 3 to 5, the image transmission apparatuses at the plurality of ground-end devices (e.g., ground-end device 1, ground-end device 2, . . . , ground-end device m, where m is a positive integer) are configured to cooperate with the UAV, thereby obtaining the images shot by the plurality of shooting devices (which may include shooting device 1, shooting device 1, , the shooting device n, where n is a positive integer) of the UAV.

In some embodiments, each ground-end device may include at least one of a remote control, a removable device (e.g., a mobile phone, a smart watch, a tablet computer, or the like), or a head-mount display device (e.g., a video glasses). The ground-end device is not limited to the devices described above, but can also include other devices that can communicate with the UAV.

The image transmission apparatus at each of the plurality of ground-end devices may include a second processor and a display. The second processor can be communicatively connected with the first processor of the UAV. The second processor and the first processor of the UAV can be connected using, for example, at least one of a wired communication or a wireless communication, which can be selected according to needs. In some embodiments, the second processor of each ground-end device and the first processor can be connected using the wireless communication, which does not limit the flying distance of the UAV. The second processor can receive the images shot by the plurality of shooting devices of the UAV and broadcast by the first processor, based on the wireless communication. The display can be communicatively connected to the second processor. The display can be any existing type of display. In some embodiments, the wireless communication connections between the first processor and the second processors can be achieved by using a high-bandwidth, low-latency wireless transmission device, as such the simultaneous transmission of multiple video streams (having a resolution of, for example, 2160×1440, 1920×1080, or the like) can be supported.

In some embodiments, the image transmission apparatus can include one or more second processors operating individually or collectively. The second processor can be configured to receive the images shot by the plurality of shooting devices of the UAV and broadcasted by the UAV. Shooting directions of the plurality of shooting devices can be different. The display module can be configured to display the multi-channel images received by the second processor in real time, thereby supporting the multi-channel image transmission of the device. The omnidirectional information (e.g., the image information from multiple perspectives) of the location of the UAV can be transmitted to the multiple users, and the multi-directional obstacle information can be provided, and hence, the users can be guided according to the multi-directional obstacle information during the operation. The flight safety can be improved and the multiple users can be provided with the more realistic panorama experience. In addition, the multiple user's operation can be supported, such that the multiple users can work together. The image transmission apparatus can be suitable for application scenarios, such as, flying from a first perspective, security monitoring, fire protection, disaster relief, pipeline inspection, robot events, and the like.

In some embodiments, the second processor can be further configured to, before receiving the images shot by the plurality of shooting devices and broadcast by the UAV, transmit the multi-channel image request to the UAV. The multi-channel image request may include the device information of the shooting devices corresponding to the multi-channel images to be requested. The second processor of each ground-end device can receive the images shot by the shooting devices corresponding to the multi-channel images to be requested and broadcast by the UVA in response to the multi-channel image request. Therefore, some of the multi-channel images can be selectively transmitted according to actual needs of the multiple users. That is, the multi-channel images shot by all the shooting devices of the UAV do not need to be transmitted at the same time, thereby saving the channel bandwidth. Based on the device information of the shooting devices corresponding to the multi-channel images to be requested, the first processor of the UAV can obtain the images shot by the shooting devices corresponding to the multi-channel images to be requested, and then broadcast the multi-channel images to be requested obtained in real time to the second processors of the plurality of ground-end devices synchronously.

The plurality of ground-end devices can include the plurality of default ground-end devices, or can be selected according to the user requirement. For example, the plurality of default ground-end devices can include a mobile device and a head-mount device. The UAV can store the terminal identification of the mobile device and the terminal identification of the head-mount device. Any user can send the multi-channel image request to the first processor of the UAV through the default mobile device and head-mount device. After obtaining the images shot by the plurality of shooting devices of the UAV, the first processor of the UAV can broadcast the multi-channel images obtained in real time to the corresponding mobile device and head-mount device according to the terminal identification of the mobile device and the terminal identification of the head-mount device.

In some embodiments, the second processor can be further configured to, before transmitting the multi-channel image request to the UAV, receive the user instruction inputted through the display, analyze the device information of the shooting devices corresponding to the multi-channel images to be requested from the user instruction, and transmit the multi-channel image request to the first processor of the UAV according to the device information of the shooting devices corresponding to the multi-channel images to be requested. In some embodiments, the user may select the images shot by some of the plurality of shooting devices of the UAV, for example, the multi-channel images to be requested, according to the need. For example, the plurality of shooting devices of the UAV may include shooting device 1, shooting device 2, shooting device 3, and shooting device 4. Shooting device 1 can be configured to shoot the images from the forward-facing perspective of the UAV, shooting device 2 can be configured to shoot the images from the backward-facing perspective of the UAV, shooting device 3 can be configured to shoot the images from the left-facing perspective of the UAV, and shooting device 4 can be configured to shoot the image from the right-facing perspective of the UAV. When the user needs to obtain the images from the forward-facing perspective, left-facing perspective, and right-facing perspective of the UAV, the device information of shooting device 1, the device information of shooting device 3, and the device information of shooting device 4 can be inputted into the second processor of any ground-end device. The second processor of the ground-end device can generate the multi-channel image request based on the device information of shooting device 1, the device information of shooting device 3, and the device information of shooting device 4, and can transmit the device information to the first processor of the UAV. The UAV can broadcast the images shot by shooting device 1, shooting device 3, and shooting device 4 to the plurality of ground-end devices. That is, the multi-channel images to be requested are the images shot by shooting device 1, shooting device 3, and shooting device 4 to the plurality of ground-end devices. The device information can include the device identifier of the shooting device.

In some embodiments, the second processor of each ground-end device receiving the user instruction may include the following processes. The display of each ground-end device can display the list of device information corresponding to each shooting device on the current UAV. The user can select the plurality of shooting devices listed in the column as the shooting devices corresponding to the multi-channel images to be requested. After the shooting devices corresponding to the multi-channel images to be requested are selected, the multi-channel image request confirmation button on the display of the ground-end device can be pressed. The second process of any ground-end device can transmit the multi-channel image request carrying the device information of the shooting devices corresponding to the multi-channel images to be requested inputted by the user to the first processor of the UAV, thereby obtaining the images shot by the shooting devices required by the user.

In some embodiments, the device information input box is provided on the display of each ground-end device, and the user can input the device information of the shooting devices corresponding to the multi-channel images to be requested into the device information input box. After the device information is inputted, the multi-channel image request confirmation button on the display of the ground-end device can be pressed. The second processor of the ground-end device can transmit the multi-channel image request carrying the device information of the shooting devices corresponding to the multi-channel images to be requested inputted by the user to the first processor of the UAV, thereby obtaining the images of the shooting device required by the user.

The image transmission apparatus at each of the plurality of ground-end devices can further include the decoded device. The decoding device can be communicatively connected to the second processor. When the multi-channel images received by the second processor are all encoded images, the decoding device can decode the encoded multi-channel images received by the second processor, thereby restoring the image information. The display of each ground-end device can display the decoded multi-channel images in real time. The decoding device can include any existing type of decoder.

In some embodiments, when the encoded multi-channel images include the plurality of I slices, if detecting that the I slices in any channel are abnormal, the decoding device can recover the abnormal I slices. After the second processor receives the I slices corresponding to the multi-channel images, if the I slices in any channel are abnormal, the abnormal I slices can be recovered and processed, and the UAV does not required to retransmit the images having the abnormal I slices. The I slices abnormity may include the loss of intra-frame division information or inter-frame division information of the image. In some embodiments, The first processor of the UAV can synchronously broadcast the I slices corresponding to the multi-channel images obtained in real time to the second processors of the plurality of the ground-end devices according to the preset period. The second processor of each of the plurality of ground-end devices can periodically recover the images having the abnormal I slices, such that the stability of the image transmission can be strong. When the second processor of any ground-end device detects the received I slices in any channel are abnormal, the abnormal image information can be sent to the first processor of the UAV, such that the first processor of the UAV can rebroadcast the image corresponding to the abnormal image information and the second processor of each ground-end device can obtain the corresponding image again. The image abnormality information may include the device information of the shooting device and the shooting time corresponding to the abnormal image. After receiving the abnormal image information, the first processor of the UAV can search the I slices of the corresponding image and rebroadcast the searched image to the second processors of the plurality of the ground-end devices.

In some embodiments, when the encoded multi-channel images include the I-frames of the corresponding images, if the decoding device determines that the received I-frames in any channel are abnormal, the second processor can transmit the abnormal image information to the UAV, such that the UAV can rebroadcast the I-frames corresponding to the abnormal image information and the second processor of each ground-end device can obtain the corresponding image again. The I-frame abnormality can include, for example, the loss of the I-frame, the distortion rate of the I-frame being greater than or equal to the preset distortion rate, and the like. The image abnormality information may include the device information of the shooting device and the shooting time corresponding to the abnormal image. After receiving the abnormal image information, the first processor of the UAV can search the corresponding image according to the device information of the shooting device and the shooting time corresponding to the abnormal image and rebroadcast the searched image to the second processors of the plurality of the ground-end devices.

In some other embodiments, there is no need to include a separately decoding device, and the functions of the decoding device can be performed by the second processor.

The present disclosure also provides a computer-readable storage medium storing a computer program. When the computer program is executed by the first processor, the image transmission methods for the UAV in connection with FIG. 1 can be implemented. When the computer program is executed by the second processor, the image transmission methods for the UAV in connection with FIG. 2 can be implemented.

It can be appreciated that the “front”, “back”, “left”, and “right” of the UAV are based on the nose of the UAV being in front and the tail of the UAV being in back.

For simplification purposes, detailed descriptions of the operations of exemplary apparatus may be omitted and references can be made to the descriptions of the exemplary methods. The apparatuses described above are merely illustrative. The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure. Those of ordinary skills in the art can understand and implement the present disclosure without creative efforts.

As used herein, the terms “certain embodiment,” “an embodiment,” “some embodiments,” “an example,” “certain example,” “some examples,” or the like, refer to that the specific features, structures, materials, materials, or characteristics described in connection with the embodiments or examples are included in at least one embodiment or example of the disclosure. The illustrative representations of the above terms are not necessarily referring to the same embodiments or examples. Furthermore, the specific features, structures, materials, or characteristics described may be combined in a suitable manner in any one or more embodiments or examples.

Any process or step described in a flowchart of an exemplary method or elsewhere in the specification can be implemented as a module, fragment, or portion of program that includes one or more executable instructions for implementing a specific logical function or the process. The disclosed embodiments may have other implementations manners. It can be appreciated by those skill in the art that the functions may not be performed in the order shown or discussed in the specification and drawings, for example, the functions may be performed in a substantially simultaneous manner or in a reverse order.

Any process or step described in a flowchart of an example method or elsewhere in the specification can be implemented as a sequenced list of executable instructions for implement the logical functions. The sequenced list can be implemented in any computer-readable medium for an instruction execution system, apparatus, or device (e.g., a computer-based system, a processor system, or other systems calling instructions from an instruction execution system, apparatus, or device, and executing instructions), or a combination thereof. Herein, a “computer readable medium” may include any system, apparatus, or device that can contain, store, communicate, propagate, or transmit a program for instruction execution, or a combination thereof. The computer readable medium can include, but is not limited to, an electrical connecting component (electronic apparatus) having one or more wirings, a portable computer disk cartridge (magnetic device), a random access memory (RAM), a read-only memory (ROM), an erasable and editable read-only memory (EPROM or flash memory), a fiber optic apparatus, and a portable optical disk read-only memory (CDROM). In addition, the computer-readable medium may include a paper or other suitable medium on which the program can be printed. For example, the program can be obtained electronically by optically scanning paper or other medium, followed by editing, interpretation, or other suitable processing as necessary, and then the program can be stored in a computer memory.

The example embodiments described above can be implemented in a computer software, electronic hardware, firmware, or a combination thereof. Some or all processes of a method consistent with the disclosure can be implemented in a software or firmware stored in a memory and executed by a suitable instruction execution system. For example, the method is implemented by the hardware, a discrete logic circuit having a logic gate circuit for implementing a logic function on a data signal, an application-specific integrated circuits having suitable combinational logic gate circuits, a Programmable Gate Array (PGA), a Field Programmable Gate Array (FPGA), or a combination thereof, can be used.

It can be appreciated by those skill in the art that some or all of the processes of a method consistent with the disclosure can be implemented by a program instructing a hardware. The program may be stored in a computer-readable storage medium, and when executed, the program can implement one or a combination of processes of the disclosed methods.

In addition, the functional units in the various embodiments of the present disclosure may be integrated in one processing unit, or each unit may be an individual physically unit, or two or more units may be integrated in one unit. The unit can be implemented in the form of hardware or in the form of computer program. When the computer program can be sold or used as a standalone product, the unit can be stored in a computer-readable storage medium. The storage medium may include a read-only memory, a magnetic disk, or an optical disk.

It is intended that the disclosed embodiments be considered as exemplary only and not to limit the scope of the disclosure. Changes, modifications, alterations, and variations of the above-described embodiments may be made by those skilled in the art within the scope of the disclosure.

What is claimed is:

1. An image transmission method comprising:
obtaining multi-channel images shot by a plurality of shooting devices of an unmanned aerial vehicle (UAV), shooting directions of the plurality of shooting devices being different; and
broadcasting the multi-channel images obtained in real time to a plurality of ground-end devices synchronously.

2. The method of claim 1, further comprising:
encoding the multi-channel images before broadcasting the multi-channel images to the plurality of ground-end devices.
wherein broadcasting the multi-channel images includes broadcasting the encoded multi-channel images to the plurality of ground-end devices synchronously.

3. The method of claim 2, wherein:
the plurality of shooting devices are coupled to a plurality of encoding devices, respectively; and
encoding the multi-channel images includes encoding images shot by one of the shooting devices using a corresponding one of the encoding devices.

4. The method of claim 2, wherein:
the plurality of shooting devices are coupled to a single encoding device; and
encoding the multi-channel images includes encoding the multi-channel images using the single encoding device.

5. The method of claim 2, wherein:
encoding the multi-channel images includes dividing the images corresponding to each channel into a plurality of I slices; and
broadcasting the multi-channel images includes broadcasting the I slices corresponding to the multi-channel images to the plurality of ground-end devices synchronously.

6. The method of claim 5, wherein broadcasting the I slices includes broadcasting the I slices according to a preset period.

7. The method of claim 2, wherein:
encoding the multi-channel images includes obtaining I frames of the images corresponding each channel; and
broadcasting the multi-channel images includes broadcasting the I frames corresponding to the multi-channel images to the plurality of the ground-end devices synchronously.

8. The method of claim 2, further comprising, after broadcasting the encoded multi-channel images:
receiving abnormal image information transmitted by one of the ground-end devices;
obtaining multi-channel images corresponding to the image abnormal information; and
broadcasting the multi-channel images corresponding to the image abnormal information to the plurality of ground-end devices.

9. The method of claim 8, wherein the image abnormal information includes device information of the shooting device and a shooting time corresponding to an abnormal image.

10. The method of claim 1, wherein broadcasting the multi-channel images includes broadcasting the multi-channel images in response to a condition being determined to be satisfied.

11. The method of claim 10, wherein the condition includes receiving a multi-channel image request sent by one of the ground-end devices.

12. The method of claim 11, wherein the multi-channel image request includes device information of the shooting devices corresponding to requested multi-channel images.

13. The method of claim 12, wherein:
obtaining the multi-channel images shot by the plurality of shooting devices includes obtain the images shot by the shooting devices corresponding to the requested multi-channel images according to the device information; and
broadcasting the multi-channel images includes broadcasting the multi-channel images obtained in real time by the shooting devices corresponding to the requested multi-channel images to the plurality of ground-end devices synchronously.

14. The method of claim 1, wherein broadcasting the multi-channel images to the ground-end devices includes broadcasting the multi-channel images to the ground-end devices synchronously via a wireless communication.

15. The method of claim 1, further comprising, before broadcasting the multi-channel images:
receiving terminal information corresponding to the plurality of the ground-end devices inputted by a user;
wherein broadcasting the multi-channel images includes broadcasting the multi-channel images to the ground-end devices synchronously according to the terminal information.

16. The method of claim 1, wherein the plurality of ground-end device include at least one of a remote controller, a mobile device, or a head-mount device.
